(19) United States
(12) Patent Application Publication
(10) Pub. No.: US 2007/0139658 A1
(43) Pub. Date: Jun. 21, 2007

(54) Luminous projecting device for the topography of spherical and non-spherical reflective surfaces

(76) Inventors: Cassius Riul, Franca (BR); Liliane Ventura, Sao Carlos (BR)

Correspondence Address: KILE GOEKJIAN REED & MCMANUS, 1200 NEW HAMPSHIRE AVE, NW, SUITE 570, WASHINGTON, DC, 20036, US

(21) Appl. No.: 11/585,884

(22) Filed: Oct. 25, 2006

(30) Foreign Application Priority Data
Dec. 21, 2005 (BR) PI 0505742-6

(51) Int. Cl. G01B 11/24

(52) U.S. Cl. 356/612

(57) ABSTRACT

A luminous projecting device for the topography of spherical and non-spherical reflecting surfaces, adapted to a slit lamp, and/or any other focused and projected light source illumination system, which uses the illumination system of this equipment as its own lighting source, and evaluates the reflected images of the continuous, concentric and illuminated target circles projected on the surfaces intended to be measured, with several dimensions in accordance with the specific image size, and its distance to the eye.

### BACKGROUND OF THE INVENTION

The present invention claims the benefit of the priority date of Brazilian Patent Application No. PI 0505742-6 of Dec. 21, 2005.

The present invention consists of a device—luminous target based on Placido rings—specially researched and developed to be used in accurate topographical measurements of spherical and non-spherical reflecting surfaces.

The topography performed by a reflected image of an object from a polished mirrored surface is based on the deformation of the image resultant from the relief of the surface where the object has been reflected. This image is usually compared to a previous standard image of a regular surface.

Topography based on reflected images is a frequently used technique in ophthalmology. In this case the lachrymal layer, providing topographical analysis of the anterior surface of the cornea, reflects the topographical target. Usually the image of topographical analysis is of concentric black and white rings, as shown in FIG. 4. These rings are known as Placidos's rings (Tasman W, Jaeger E A editors. Duane's clinical ophthalmology. Philadelphia: J B Lippincott; 1991). The targets used for video topography use self illumination in order to highlight the white and black rings. The present invention overcomes this limitation of self illumination, where electrical cables are necessary, by using the illumination system from the slit lamp (ocular microscope), providing wireless target mire, with high contrast image of the white an black rings. As the slit lamp is an instrument for the human eye observation, the reflected image of the target onto the cornea, may be observed in order to perform the topographical measurements.

Similarly, if any other shape apart from circles is performed on the target, it will not deprive the invention from its features, as mentioned, because the topographic analysis is performed regarding the deformations of the target formed image according to the relief of the surface.

In order to achieve a uniform illumination of the target mire, a mirrored conical surface has been designed to reflect the light, thus allowing the illumination of the discs (rings in relief), at different diameters and different distances. So, the focusing angle of the slit lamp lighting system is taken into consideration, so that the light can be reflected, and deviated to the desired proper locations.

### OBJECTS AND SUMMARY OF THE INVENTION

The invention was built to work within a slit lamp and/or any other focused and projected light source lighting system. The light is deviated and reflected by the mirrored conical and/or cylindrical surfaces, projecting it circularly, thus obtaining a full and homogeneous illumination of the rings, which compose the target.

The side view of the invention is shown in FIG. 1.

The mechanism of the invention provides the illumination of the areas indicated by (1) in FIG. 1—face in relief, which can be mirrored, or not, on a number equal to or greater than 01—from the light of the slit lamp. Therefore, this illuminated target can be reflected by the reflecting surface to be measured.

The parts in relief are highlighted and are responsible for the light rings presented on the reflected image. The intervals between a light and a dark ring are responsible for the dark rings presented on the reflected image.

The developed device can be divided into four parts: inner cone; outer cone; transparent support; and, limiting element.

The objective of the inner cone, as indicated by (3) in FIG. 1 and individually shown in FIGS. 2, 2a, and 2b, intercepts and reflects through its outer surface as indicated by (6) in FIG. 2,—mirrored surface for allowing light reflection—the light coming from the illumination system of the slit lamp towards the outer cone surfaces in relief. The central passing hole, as indicated by (7) in FIG. 2, enables the light to pass through it and works as a fixation point for the patient as a light spot at the base of the cone. Such hole is positioned at the central axis of the focusing optical system.

The outer cone, as indicated by (4) in FIG. 1 is shown individually in FIGS. 3, 3a, 3b, and 3c, composed by a cylindrical part with an inner hole (8), cone-shaped and with some faces in relief (9). Such faces may, or not, be polished, and are highlighted from the remaining portions of that part when receiving the light from the inner cone, which is homogeneously distributed among such surfaces.

The faces in relief of the inner conic hole are projected so that the image reflected by the lachrymal layer results, as previously mentioned, in an image similar to the rings of Placido's disc, that is, it provides an image similar to the one shown in FIG. 4. The dimensions of the reflected images are dependent on the distance of the outer cone to the reflective surface as well as on the cone's dimension. The physical dimensions of the angle of the inner conic hole of the outer cone and the widths of the surfaces in relief may be altered conveniently to the desired image that one should obtain.

FIGS. 5, 5a, and 5b individually illustrate the transparent support (5), which is also shown as (5) in FIG. 1. This part is a tube that supports the central cone and connects to the limiting element. Since it is made of transparent material, it allows that the reflected image of the inner cone passes through. The use of such transparent support prevents the image from discontinuity. It works as a fixation support for the inner cone, allowing the light to pass through it. Its dimensions may vary according to the variation of the dimensions of the target. The light-limiting element, shown as (2) in FIG. 1, and individually in FIGS. 6, 6a, and 6b, is for limiting the output light from the slit lamp illumination system; therefore, the filament rectangular shape does not interfere with light homogeneity. Hence, the light passing through the limiting element is homogeneous and circular.

The light-limiting element also connects the outer cone and the transparent device.

FIG. 1, as previously mentioned, shows the invention with all the four parts connected: inner cone (3), outer cone (4), transparent device (5) and light-limiting element (2).

The target may be used for different types of illumination, performing measurements of any reflecting surfaces, not being limited to ocular measurements.

The light filament from the illumination system of the slit lamp, (10) FIG. 7 “a” is projected on the output lens of the illumination system itself, (11) in FIG. 7.

The mathematical formalism for designing the target considers the luminous area limited between the first (12) and the last (13) circles, and denominated as area for calculation (14), in FIG. 7. Illumination homogeneity is achieved by the light-limiting element, which is part of the invention, indicated by (15) in FIG. 7 “a”.

As the focusing distance of the emerging light from the system is known, and as a coordinate on the projected filament may be selected, it is possible to trace an imaginary ray from such point to the focal point. Therefore, the reflecting surface angles may be determined. In order to optimize calculations, coordinates were chosen on both the first (12) and last (13) circles—extreme borders of the calculation area—in FIG. 7. Then, it is simple to obtain the focalization angle of the referred ray related perpendicularly to the illumination system axis and that passes through the focus.

Then, it is possible to deflect such light rays to the intended points, using the reflecting surfaces.

What really matters is not the illumination of the cornea or the reflecting surface intended to be measured, but the illumination of the faces shown on (1), FIG. 1, since the objective is to obtain the reflection of the illuminated target on the lachrymal layer of the cornea and/or of the reflecting tested surface. In this sense, light positioning towards the focus point is only required for optimizing the system, because it provides a single focusing feature, thus making the centralization easier when the measurement is performed.

FIG. 8 shows the target placed on the slit lamp, in front of the optical system on (16), and the illumination system on (17). The light path is represented by the rays (18) and (19) on the same figure, which are deviated at (20)—inner cone—towards (21)—outer cone. Therefore, the surface to be measured, in (22), can reflect the target; such reflex can be seen from the slit lamp's optical system (16).

FIG. 9 shows in details, the deviation by the inner cone on (23), of an imaginary light ray on (24), with the corresponding incidence and deviation angles, until reaching one of the faces in relief of the outer cone (25).

By attaching the target in front of the slit lamp, the light used for illuminating the patient's eye, also illuminates the projection target.

At (26) in FIG. 10, it can be noticed that on the fixation part of the inner cone with the glass support there is a portion of the transparent support that is not covered by the inner cone. Such part depicts a difference among its rays, and it was left there on purpose, as it could work as another illuminated surface, providing another disc to the image, which will be the smallest one among all lighter discs of the target.

The invention dimensions will vary in accordance with the specific image size intended to be evaluated, and its distance from the eye and/or measured surface. The part herein described depicts 11 (eleven) discs and one fixation point providing an image—when reflected by a spherical surface—similar to the one shown in FIG. 11, where the fixation point is indicated by (27), and the disc (28) refers to the transparent support. The space indicated by (29) on the image, at the same FIG. 11, is larger than the other, because it refers to the space left for observing through the slit lamp. This space (30) is also shown in FIG. 12, which presents a perspective view of the target coupled to the slit lamp—patient's side of view—is composed by the base of the inner cone (31); the outer cone (32), transparent device (33); light-limiting element (34); illumination system of the slit lamp (35); objective lens of the slit lamp, where the reflected image reaches the optical system of the slit lamp (36).

The invention set up is simple, and does not present any difficulty in setting it up, especially because it is cable-free. The set up is done just by attaching it to the slit lamp lighting system head.

Regarding the state of the art, nothing has been found on the market resembling the invention herein proposed. Due to such gap, the present patent of this device was prepared and construed, thus allowing, among other things, to perform cornea topography with a slit lamp, using its own illumination.

The benefits are: significantly reduced size, privileged location, and slit lamp adaptation, besides being independent from extra light sources.

The patent now claimed meets the commercial, industrial and medical principles. It is economically feasible and featuring a strictly social concept, therefore meeting its constitutional purposes, which are the social interests, and the technological and economical development of the country.

### THE DRAWINGS

In order to have a clear idea of the invention, illustrative drawings attached in order are provided to better clarify the detailed description of the following items:

FIG. 1 shows the side view of the invention, wherein: (1) are the faces in relief to be illuminated and that will be highlighted; (2) is the light limiting element; (3) the inner cone; (4) the outer cone; (5) the transparent support.

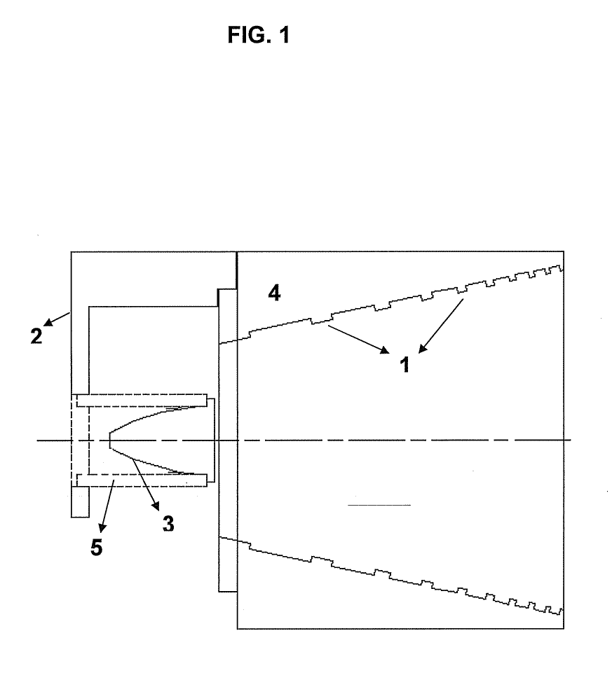

FIGS. 2, 2a, and 2b depict the inner cone individually, wherein: (6) is the reflective face; (7) is the passing through hole, which enables the light to pass through it and works as a fixation point for the patient.

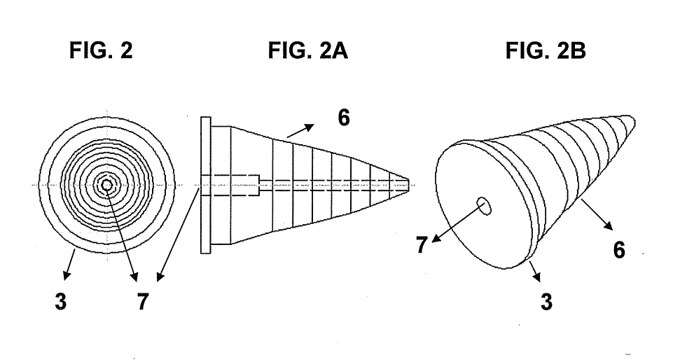

FIGS. 3, 3a, 3b, and 3c depict the outer cone individually, wherein: (8) is the conical holes of the cylindrical part; (9) are the faces in relief.

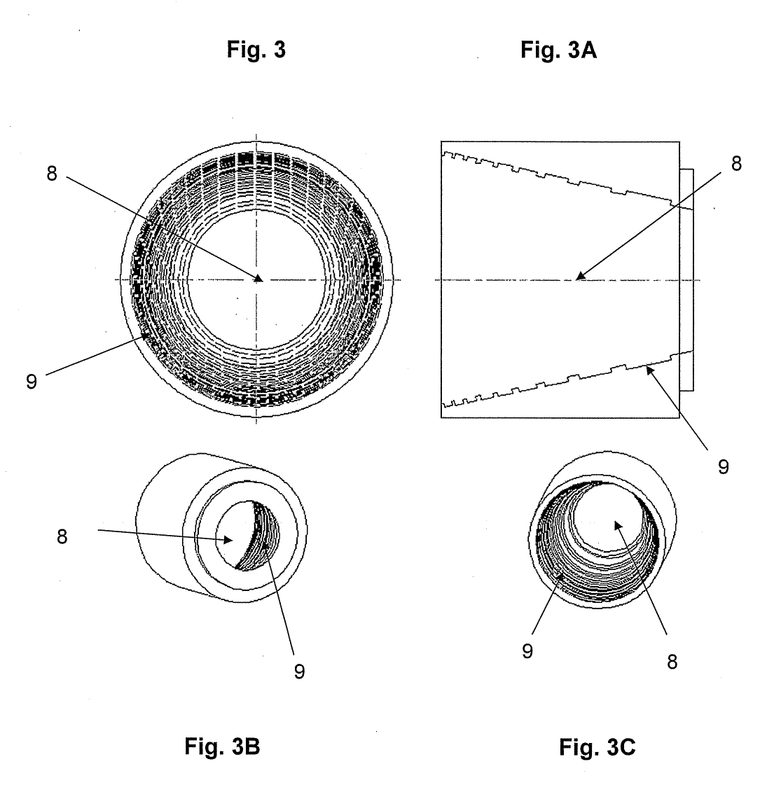

FIG. 4 shows how the Placido's discs should be reflected by a spherical surface.

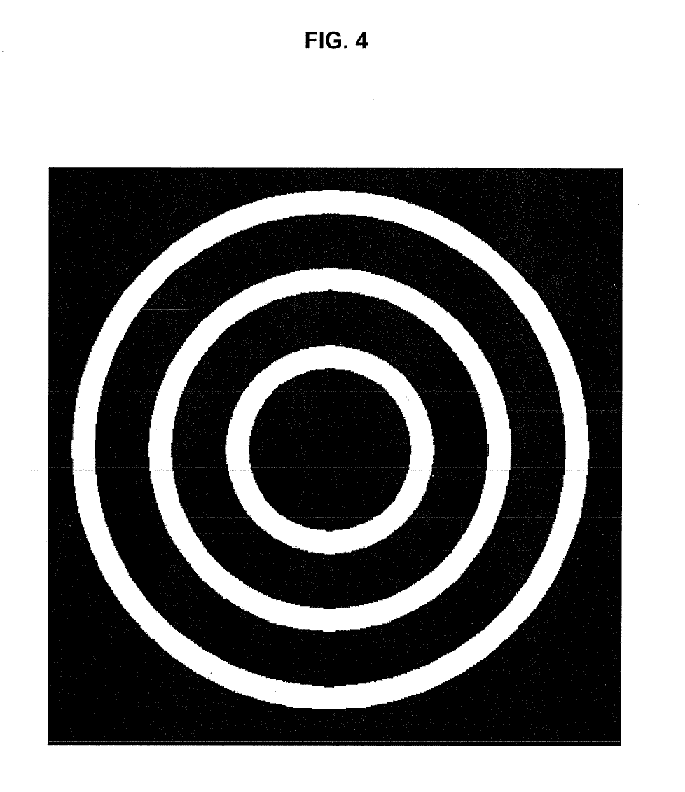

FIGS. 5, 5a, and 5b, depict the transparent support (5).

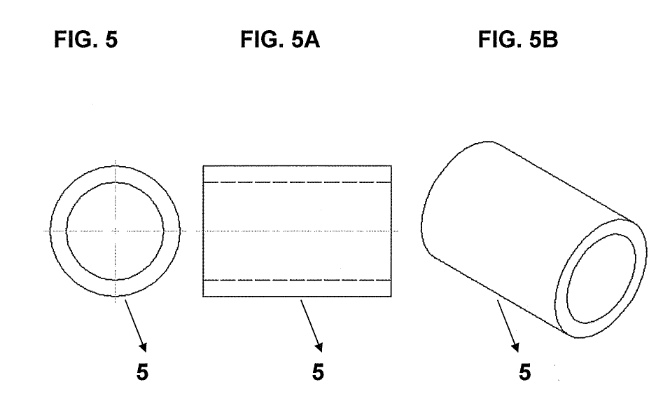

FIGS. 6, 6a, and 6b show the light limiting element (2).

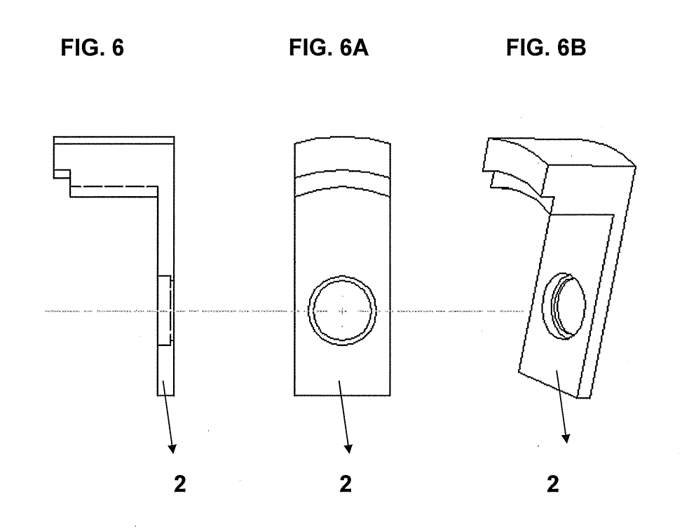

FIGS. 7 and 7a represent the light output from the illumination system, and how much light is used for illuminating the target, wherein: (10) represents the light filament from the illumination system of the slit lamp, (11) represents the output lens of the illumination system itself; (14) stands for the area used for the dimensional calculation of the target; (12) and (13), are the circles delimiting the calculation area; (15) shows how the light limiting element actuates on the target.

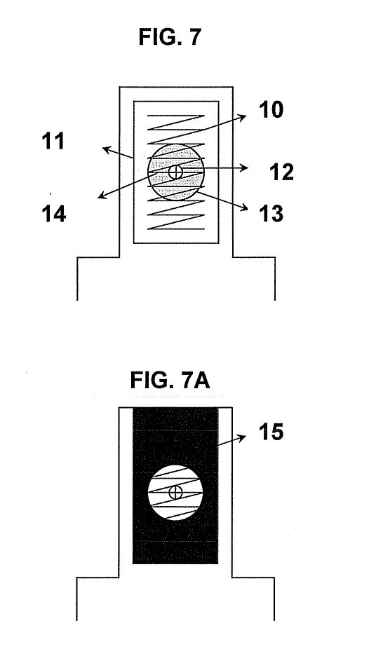

FIG. 8 shows the invention coupled to a slit lamp, wherein: (16) is the slit lamp's optical system; (17) stands for the slit lamp's illumination system; (18) and (19) represent the rays coming from the illumination system and are deviated in order to illuminate the outer cone; (20) represents the inner cone; (21) represents the outer cone; (22) represents the surface to be measured.

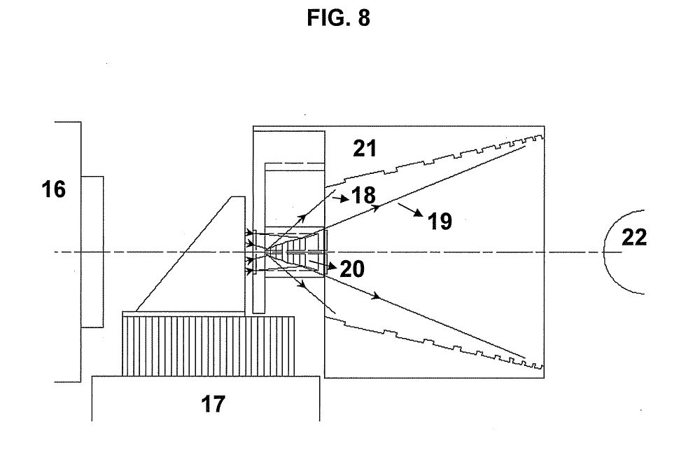

FIG. 9 shows the light deviation by the reflecting surfaces, wherein: (23) is the inner cone surface; (24) is the ray coming from the slit lamp's illumination system, and which is deviated to the outer cone; (25) depicts an outer cone face in relief.

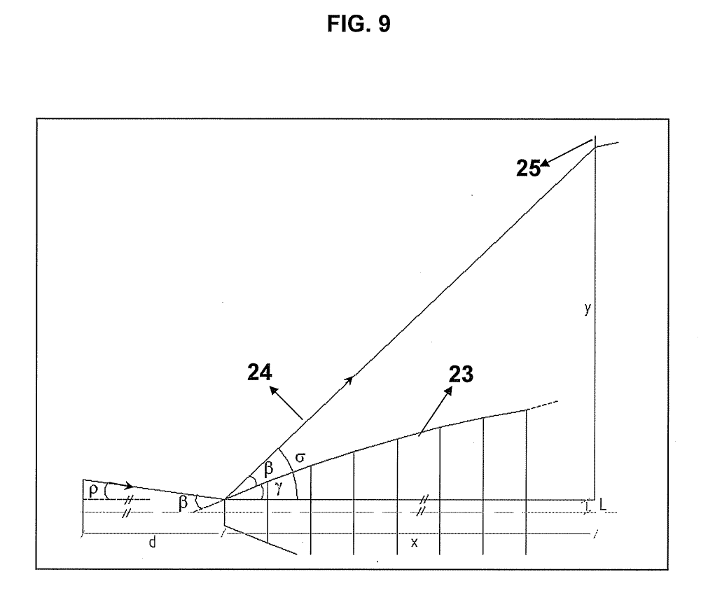

FIG. 10 shows the transparent support and the inner cone union, wherein: (26) is the portion of the transparent support that is illuminated, thus forming another illuminated surface providing the smallest lighter disc.

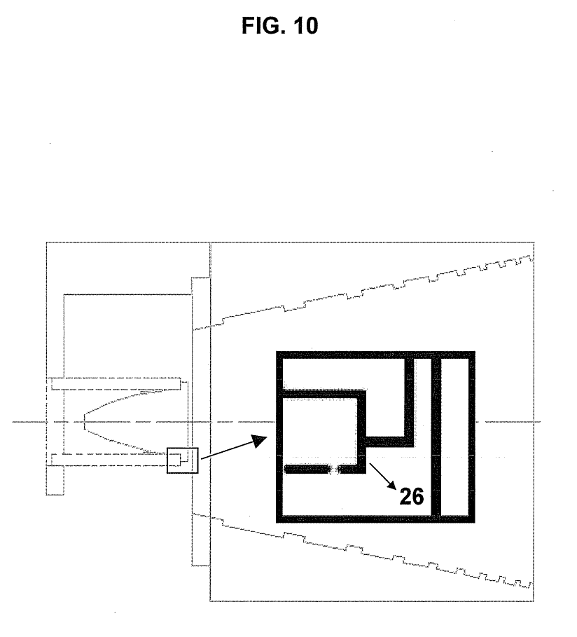

FIG. 11 depicts an image that would be formed by the reflection of a 12 discs target, wherein (27) represents the fixation point reflex; (28) depicts the smallest disc, regarding the transparent support surface; (29) is the space left for observing through the slit lamp.

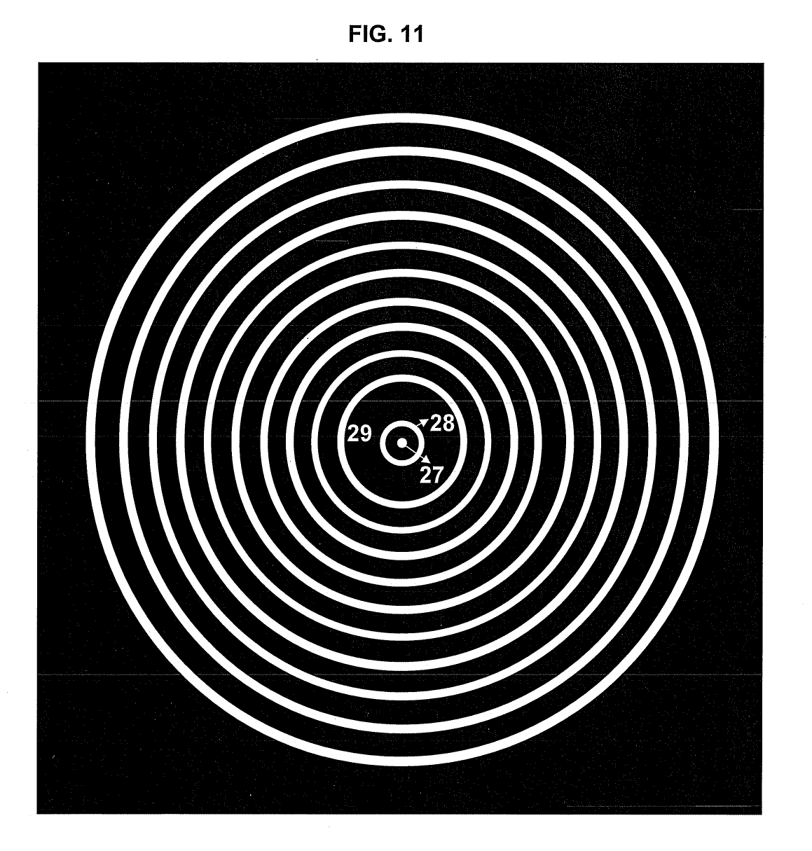

FIG. 12, which presents a perspective view of the target coupled to the slit lamp—patient's side of view—shows a space left for observing through the slit lamp (30), which is composed by the base of the inner cone (31); the outer cone (32), transparent device (33); light-limiting element (34); illumination system of the slit lamp (35); objective lens of the slit lamp, where the reflected image reaches the optical system of the slit lamp (36).

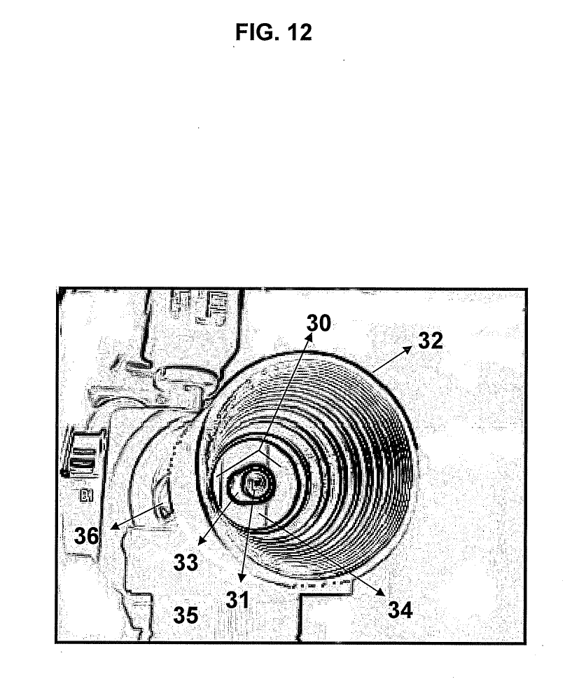

As already mentioned, the explanation of the present invention is merely illustrative, and changes may occur on some details, especially regarding the size, shape, dimension, manufacturing, industrial availability, but always observing the conceiving of the principle, to the extent indicated by the knowledge of the claims attached to the present patent application.

As it is known, a patent shall incorporate innovative features, and feature commercial and industrial applications; the present invention meets such requirements, showing unique principles and features regarding the remaining products, and due to its benefits, arising technical effect and innovative features shown, it fulfils the conditions required for meeting the claimed priority.

1- A luminous projecting device for the topography of spherical and non-spherical reflecting surfaces characterized by a device used for accurate topographically measuring spherical and non-spherical reflecting surfaces, adaptable to a slit lamp, using such equipment's illumination system as its own light source, for analyzing images formed by the reflection of continuous, concentric and illuminated discs on the surfaces to be measured, which dimensions vary in accordance with the image specific size intended to be evaluate and its distance from the eye.

2- A luminous projecting device for the topography of spherical and non-spherical reflecting surfaces, in accordance with claim 1, characterized by enabling target measurements on the surfaces, by any means other than discs, without depriving the invention from its features, due to the fact that the topographical analysis is conducted based on the target's image deformations reflected by the reflecting surface, regardless of its shape, thus enabling, on its original shape, to perform corneal topography based on Placido discs.

3- A luminous projecting device for the topography of spherical and non-spherical reflecting surfaces in accordance with claim 1, characterized by own mirror-like conical surfaces for an even reflection, reflecting the largest amount of light possible, illuminating the several discs forming the target on the corresponding different diameters and distances, in accordance with the slit lamp and/or any other focused and projected light source lighting system focusing angle where the light is reflected on mirror-like conical and/or cylindrical surfaces, intended for deviating it circularly, thus obtaining a full and homogeneous target lighting, so the light can be reflected and deviated to the desired proper locations.

4- A luminous projecting device for the topography of spherical and non-spherical reflecting surfaces in accordance with claim 1, characterized by illuminating faces in relief, which can be mirror-like, or not, on a number equal to or greater than 01, from the light coming from the slit lamp lighting, so that the illuminated target—used for different types of lighting—can be reflected by the reflecting surface to be measured, and providing measurements of any reflecting surfaces, not being limited to ocular measurements.

5- A luminous projecting device for the topography of spherical and non-spherical reflecting surfaces in accordance with claim 1, characterized by its inner cone, which is intended to reflect through its external surface the light coming from the slit lamp lighting system towards the outer cone surfaces in relief, this cone owns a central hole, located on the optical system focusing central axis, which allows it passes and serves as fixation point for the patient.

6- A luminous projecting device for the topography of spherical and non-spherical reflecting surfaces in accordance with claim 1, characterized by its outer cone, a cylindrical part with an inner hole and some faces in relief, which may be, or not, polished and dimensioned, so that the image reflected by the lachrymal film results, as previously mentioned, on an image similar to the Placido disc, and that are highlighted from the rest of the part upon receiving the light coming from the inner cone, which is homogeneously distributed along such surfaces.

7- A luminous projecting device for the topography of spherical and non-spherical reflecting surfaces, in accordance with claim 1, characterized by a transparent support, a tube which supports the central cone and is connected to the limiting element, letting the light reflected by the inner cone to pass, thus avoiding sections on the image.

8- A luminous projecting device for the topography of spherical and non-spherical reflecting surfaces in accordance with claim 1, characterized by a light limiting element, which is intended to limit the slit lamp lighting system output light, so the filament rectangular shape will not disturb the lighting homogeneity, thus making the light passage to occur on a homogenous circular fashion. Focusing the light leaving the system, and choosing a point on the projected filament, drawing an imaginary ray from such point to the focus point, by calculating the reflecting surface angles, through the points on both initial and final circles, boundaries of the calculation area, regarding the perpendicular axis to the lighting system, passing through the focus point, which can deflect these light rays to the intended points through the reflecting surfaces.

9- A luminous projecting device for the topography of spherical and non-spherical reflecting surfaces in accordance with claim 1, characterized by fixing the inner cone onto the glass support, and a part of the transparent support, which is not covered by the inner cone, with a difference between its rays, left on purpose, so it could work as another illuminated surface, thus providing another disc on the image, which will be the smallest among all discs.

10- A luminous projecting device for the topography of spherical and non-spherical reflecting surfaces in accordance with claim 1, characterized by 12 discs, and one of such discs represents the fixation point reflex (27), another refers to the transparent support (28), thus providing an image, when reflected by a reflecting surface, which would be formed by reflecting the manufactured part, due to the space (29) left for observing through the slit lamp.
